(19) United States
(12) Patent Application Publication
(10) Pub. No.: US 2006/0104757 A1
(43) Pub. Date: May 18, 2006

(54) Device for conveying bulk material

(76) Inventors: Klaus-Sweerich Schroder, Aalen (DE); Jens Quitte, Aalen (DE); Stephan Timmermann, Aalen (DE)

Correspondence Address: RATNERPRESTIA, P O BOX 980, VALLEY FORGE, PA, 19482-0980, US

(21) Appl. No.: 11/236,159

(22) Filed: Sep. 27, 2005

(30) Foreign Application Priority Data
Sep. 28, 2004 (DE) 10 2004 046 993.8

(51) Int. Cl. B65G 65/00

(52) U.S. Cl. 414/310

(57) ABSTRACT

A device for conveying a bulk material comprises a base with a bearing suit to provide a bearing for the device so that it rotates about a rotation axis, a conveyor unit projecting out from the base, a roof for the base and the conveyor unit, and a drive. The conveyor unit forms at least a transverse conveyor for conveying the bulk material transversely to the rotation axis or at least one feeding conveyor for feeding the bulk material to a transverse conveyor of this type. The roof is joined to the base so as to rotatable about the rotation axis. The invention also includes a drive, so that the roof can be driven in rotation relative to the base.

### BACKGROUND OF THE INVENTION

1. Technical Field

The invention relates to a device for conveying bulk material, which bears down on the device in the form of a column of bulk material. The device is particularly suitable for use in large silos as a means of discharging the bulk material from the silo. The invention further relates to a store for bulk material incorporating the device as well as a method of conveying bulk material using the device.

2. Description of the Related Art

It is common practice to use rotating screws in large capacity silos. The rotating screw is mounted in the centre of the silo in a rotatable tower and may be an overhanging or supported conveyor screw. The conveyor screw is driven by means of a flange-mounted gear mechanism or by means of a chain drive and conveys the bulk material through the tower out of the silo. In order to activate the entire silo floor, the tower is displaced in a slow rotating motion so that the conveyor screw slowly rotates about the vertical mid-axis of the silo. Equipped with tearing teeth, it digs through the bulk material. In the case of tall silo heights and large silo diameters and a correspondingly high and wide column of bulk material, the pressure exerted on the tower of the conveyor screw by the bulk material rises enormously. In order to minimize the driving torque needed to rotate the tower, the cover or roof of the tower is mounted so that it can rotate on a base of the tower. During operation of the conveyor screw, the tower base rotates slowly underneath the roof whilst the roof is retained due to the friction of the bulk material. As the filling level rises, there is an increased risk of a stable bridge of bulk material forming. This being the case, the non-rotating roof constitutes an ideal bridge base. Also in the case of conically shaped roofs and domed roofs, there is a danger of a stable bridge of bulk material forming from the vertical silo wall to the roof of the screw tower. In order to reduce the risk of a bridge base forming, the roof may be fixedly connected to the tower base of the conveyor screw. However, because of the friction between the roof and bulk material and the ratio of the roof surface area to the external surface of the tower base, the fixed connection causes a torque approximately 50% greater than is the case with roofs mounted so as to be freely rotatable.

### SUMMARY OF THE INVENTION

It is an object of the invention, based on a device of the type outlined above, to counteract the formation of a stable bridge base whilst keeping the driving torque needed to drive the rotating motion low.

The invention is based on a device for conveying bulk material, comprising a base with a bearing unit to provide a bearing for the device so that it rotates about a rotation axis, a conveyor unit projecting out from the base for conveying the bulk material and a roof which is connected to the base so as to be rotatable about the rotation axis or about an axis offset from and at least substantially parallel with the rotation axis. The bearing unit may be a complete rotary bearing or a component of a rotary bearing, for example a roller track or a slide track about the rotation axis. The conveyor unit is supported on the base so that when the base is driven in rotation, it pivots about the rotation axis and in this sense rotates about the rotation axis. It preferably extends out in a freely overhanging arrangement but may alternatively also be supported, for example on a peripheral guide on a wall of a bearing container or by means of a supporting device likewise standing proud of the base. The base forms the bearing platform for the conveyor unit and may advantageously be designed as a tower structure with a casing as is the case with the known devices. A casing of this type may even already form the base in principle. The roof should cover at least the part of the base from which the conveyor unit overhangs in order to protect the bearing point or several bearing points of the conveyor unit and a drive for the conveyor unit, which is preferably mounted on the base, from the bulk material bearing down on the roof when the device is operating. Consequently, a roof surface formed by the roof is sealed at least over the bearing of the conveyor unit, to the degree that no bulk material is able to fall onto the bearing. By preference, the roof surface is a fully closed surface with no orifices.

The conveyor unit may be a conveyor screw in particular. Alternatively or in addition to a conveyor screw, the conveyor unit may be provided in the form of a rotating cutter, in particular a conveyor chain, which rotates about a supporting and guiding means, similar to an oversized motor-driven chain saw. In yet another alternative, a component of the conveyor unit rotating with the base is not actually a transverse conveyor, i.e. is not a conveyor element which conveys the bulk material transversely to the rotation axis, but a feeding conveyor which conveys the bulk material to a non-rotating, stationary-mounted transverse conveyor. The feeding conveyor may be a drag arm, preferably with scarifiers, which acts like a rabble arm when driven in rotation. A conveyor screw or conveyor chain, for example, may be used as the stationary transverse conveyor. Although it is preferable to use a single conveyor as a conveyor unit, at least in the case of the transverse conveyor rotating with the base, the conveyor unit may in principle also consist of several conveyor elements overhanging the base distributed about the rotation axis, for example conveyor screws.

As proposed by the invention, the device has a drive, by means of which the roof can be driven in rotation about the rotation axis relative to the base. The reaction torque which occurs when the roof is driven in rotation is advantageously absorbed by the base because the drive, base and roof are preferably kinematically coupled with one another. The rotation speed of one, either the roof or base, is clearly determined by the rotation speed of the other as a result of the kinematic coupling. The coupling preferably transmits the reaction torque positively, i.e. slip-free. If some slip does occur in the coupling, it should be so low as to be negligible for practical purposes, which is the case with a kinematic coupling of the housing. The reaction torque is preferably used to drive the base in rotation in the opposite direction of rotation. It is of particular advantage if a motor of the drive is supported on the base, for example so that it rotates with the base about the rotation axis, optionally at a higher or lower speed. Alternatively, the motor may be supported on the roof and rotate with it, optionally at a higher or lower speed. In principle, the motor may also be supported on a frame designed to bear and enable the base to rotate and the drive is split with one drive branch to the base and another drive branch to the roof.

Another drive is preferably provided as a means of driving the base in rotation. A motor of the other drive is preferably supported on the base and rotates with it about the rotation axis, optionally at a higher or lower speed. However, the motor of the other drive may also be supported on a frame, relative to which the base rotates as it is driven in rotation about the rotation axis.

By using at least two drives, namely one drive for the roof and another drive for the base, the operating range of the device can be extended to cope with larger storage containers, in particular silos, and/or heavier bulk materials. As regards the preferred embodiment in which the base absorbs the reaction torque for driving the roof in rotation, it is already of advantage, irrespective of the number of motors, that the reaction torque simultaneously also constitutes the driving torque for the base and is not wasted. As the column of bulk material increases in height and the friction between the bulk material and roof increases as a result, only the reaction torque increases. As a result, the torque needed for the rotating motion decreases because the effect of overcoming the roof friction, i.e. the friction between the roof and the bulk material bearing down on it, is used to drive the rotating motion of the conveyor unit. At low filling levels and when the torque needed to drive the roof is low accordingly, on the other hand, a low reaction torque is also generated on the part of the base so that the roof drive absorbs less power accordingly and is subjected to less wear, which also applies to the bearing and the conveyor unit.

A more uniform conveying rate can also be achieved when discharging a column of bulk material as a result of the invention. If the drive generates a constant torque throughout the discharge duration, as is standard practice, the rotation speed of the conveyor unit increases as the height of the column of bulk material decreases. The filling level of the conveyor unit increases accordingly. However, if the same driving torque is split and applied to the drive for the base and the drive for the roof as proposed by the invention, the roof rotates faster as the column height decreases because the decreasing weight of the column of bulk material primarily bears on the roof. The sliding friction between the roof and the bulk material and hence also the torque transmitted from the roof to the base decrease. The rotation speed of the base primarily increases only in the same proportion as the sliding friction acting between the bulk material and the base and the weight of the bulk material acting on the conveyor unit decrease. Compared with conventional devices, acceleration due to the decreasing column height is reduced by the amount induced by the decreasing sliding friction between roof and bulk material as a result. Since the conveying rate is more uniform, the bulk material is conveyed less roughly. In order to save motor power, the desired value for the torque of the roof drive can be reduced, controlled or regulated during discharge. If the driving power is divided between several motors, one of the motors may be switched off or several motors can be switched off in succession.

Since the roof can be driven in rotation relative to the base, not only is it possible to prevent or least make it more difficult for a bridge base to form in the region of the roof with a low torque requirement for rotating the roof, the roof can additionally also be further modified so that it actively destroys any bridge foot. As part of such modifications, an effector device is disposed on the roof which destroys bridges formed by the bulk material. The effector device consists of at least one effector element which projects down from the roof parallel with the rotation axis or at least parallel with a directional component. The at least one effector element projects from an external face of the roof into the bulk material and is shaped so that, as the roof rotates, it breaks, cuts into, tears up or otherwise destroys bridges of bulk material disposed in the path of its rotating motion.

The at least one effector element may be a passive or an active element. If it is an active element, it is driven relative to the roof and in particular may be provided in the form of a cutting or tearing element, for example a rotating screw or sickle or a displaceable scarifier or displaceable blade. A tearing tooth is one advantageous example of a passive effector element. A spiral projecting down from the roof preferably forms the at least one passive effector element. In particular, the spiral may be provided in the form of a slim web curving in a spiral pattern about the rotation axis. The spiral should extend around at least 180°, preferably around at least 270°, of the rotation axis. On the other hand, the angle of extension should be no more than 630°. The spiral web thus forms an extended spiral, preferably a continuous web, although in principle the web may also be interrupted at certain points. The outer end of the spiral web is preferably formed on the outer roof edge or at least in the vicinity of the outer roof edge. The spiral web should extend with its inner end as far as the rotation axis.

As a result of the spiral shape, bridges of bulk material are torn apart as bulk material is shifted when it comes into contact with the rotating spiral. The web should have an overall inclination of less than 40°, preferably at most 30°, with respect to the direction of rotation of the roof. In certain sections, the inclination may even be 0°, i.e. the web forms an arc of a circle about the rotation axis in these sections. Certain sections of the web may also be straight. By preference, however, the web is a spiral in the mathematical sense, i.e. it is curved overall, in which case its radius of curvature measured to the rotation axis decreases between its outer end and its inner end.

In alternative embodiments, the effector device might comprise several passive effector elements or several active effector elements or also one or more passive and one or more active effector elements in combination.

If the roof is used as a means of destroying bridge bases, the height of the column of bulk material bearing down on the roof can be further increased because bridges of bulk material are reliably destroyed.

The drive for the roof comprises a motor and a gear mechanism which transmits the driving motion of the motor to the roof. The gear mechanism is preferably a positively transmitting gear mechanism, preferably a driving gear, although in principle it may also be or contain a traction gear, a combination of driving gear and traction gear or even a friction gear. The gear mechanism preferably comprises a driving gear and an output ring inside which the driving gear moves. The motor preferably drives the driving gear via a reduction gear. The reduction gear is preferably an epicyclic gear or planetary gear. The output ring is preferably connected to the roof so as to be fixed to it during rotation. The motor is supported on the base so that it rotates with it. In the reverse of this arrangement, the output ring may also be fixedly joined to the base so as to rotate with it whilst the motor is fixedly joined to the roof so as to rotate with it. Instead of using a gear wheel pair with an inside axis, the motor may also drive the roof by means of a gear wheel pair with an external axis, i.e. via a drive wheel which moves externally on an output ring or an output disc. In order to increase the torque for applications involving heavier bulk materials and/or high columns of bulk material, it may be of advantage if two or even more drives of this type are provided around the circumference of the output gear.

In a preferred embodiment, the roof is supported on the base via the output gear. The output gear may be a component of a rotary bearing which bears the roof so that it can rotate relative to the base, for example a slide track or preferably a roller track of the rotary bearing. The rotary bearing is preferably a thrust-radial bearing about the rotation axis. The output gear may advantageously form a bearing ring for rolling elements of the rotary bearing.

The explanations given above in respect of how the roof is driven advantageously also apply to the other drive which preferably primarily causes the base to move in rotation. The motor or motors of the other drive is or are supported on the base or on a frame which bears the base enabling it to rotate. In a preferred embodiment, the base is supported on the frame by means of an output gear of the other drive. The output gear of the other drive may be a component of a rotary bearing which bears the base so that it can rotate relative to the frame, for example a slide track or preferably a roller track of the rotary bearing. The rotary bearing is preferably a thrust-radial bearing about the rotation axis. The output gear may advantageously constitute a bearing ring for rolling elements of the rotary bearing.

In addition to the device as such, the subject matter of the invention also relates to a method of conveying bulk material whereby the roof is driven in rotation and is preferably used as a means of destroying bridges. As a result of the method, the bulk material is preferably discharged from a storage container by means of the device.

Finally, the invention also relates to a store for bulk material and the device is disposed at a centre of the storage container. The storage container is preferably a silo which is circular at least in the interior. The conveyor unit preferably overhangs as far as the casing internal surface of the silo so that the conveyor unit reaches the entire base of the silo around the rotating base.

Preferred features of the invention and their combinations are also described in the dependent claims.

### BRIEF DESCRIPTION OF THE DRAWINGS

Examples of embodiments of the invention will be explained below with reference to the appended drawings. Features which become apparent from the embodiments described as examples constitute the subject matter of the claims, both individually and in every combination of features, in addition to the advantageous embodiments described above. Of the drawings:

FIG. 1 shows a store for bulk material with a storage container, illustrating a section of its container wall, incorporating a device for conveying the bulk material disposed at the centre of the storage container,

FIG. 2 is a first variant of the device for conveying the bulk material,

FIG. 3 is a perspective view showing a part of the device in a second variant,

FIG. 4 is a side view of the second variant of the device and

FIG. 5 is the second variant of the device in a plan view onto a roof of the device.

### DETAILED DESCRIPTION

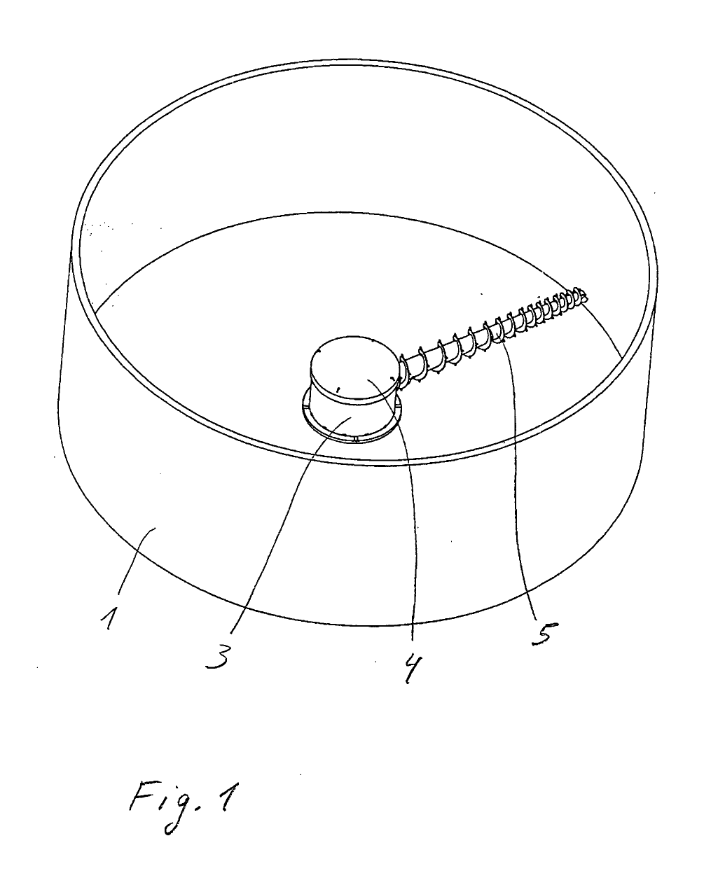

FIG. 1 shows a view down into a store for bulk materials. The bulk material store comprises a storage container, which in the embodiment illustrated here is provided in the form of a silo with a circular side wall 1. However, only one circular portion of the side wall 1 is illustrated. On a base of the storage container 1, a device for conveying bulk material is disposed at its centre. The device comprises a conveying unit 5, which in the embodiment illustrated as an example is a conveyer screw 5, as well as a tower formed by a base which is not illustrated in the drawing, a jacket 3 fixedly joined to the base so as to rotate with it and a roof 4 in the form of an at least substantially closed housing. The base is mounted on a frame of the bulk material store so that it can rotate about a vertical rotation axis U. When the tower 3, 4 is rotated, the conveyer screw 5 pivots about the rotation axis U and as it does so wipes the entire base surface of the storage container 1 extending between the tower 3, 4 and the storage container 1. The conveyor screw 5 is supported on the base and mounted so as to be rotatable about its longitudinal axis which in the embodiment illustrated as an example points transversely, radially with respect to the rotation axis U. It is driven in rotation about its longitudinal axis. When the conveyor screw 5 is driven in rotation, the bulk material in the thread pitches of the conveyer screw 5 is conveyed, i.e. carried away, radially inwards towards the tower 3, 4 and through a base of the storage container 1 out of the tower 3, 4. The conveyor screw 5 is provided with tearing teeth at the external periphery of its thread pitches, by means of which it digs through the bulk material as it is driven in rotation about its longitudinal axis and driven in rotation about the rotation axis U in the rotation direction.

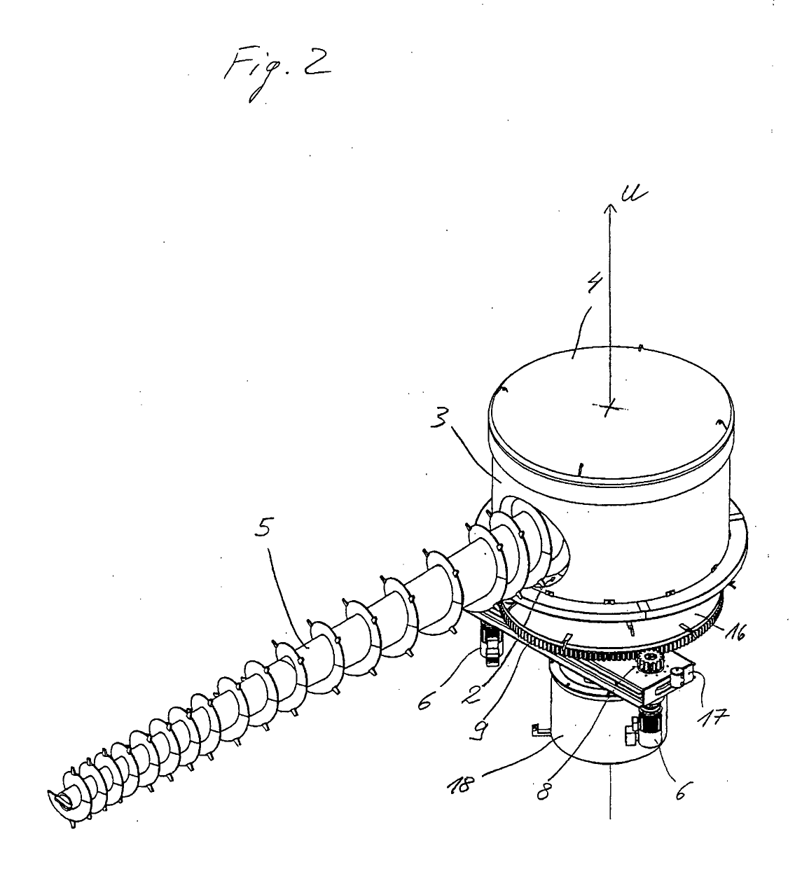

FIG. 2 illustrates a first variant of the conveyor unit, which is pre-fabricated for installation in the storage container 1. By means of its jacket 3 and its roof 4, the tower 3, 4 forms a protective housing for the bearing of the device, in particular for the bearing, conveyor screw 5 and drives of the device. The conveyor screw 5 extends out of the tower 3, 4 through an orifice in the jacket 3 in a freely overhanging arrangement. An externally toothed output gear 9 is fixedly secured to a frame 16 of the storage container 1 concentrically with the rotation axis U to prevent rotation and therefore remains immobile in a fixed position once the device has been mounted in a storage container 1. Also illustrated is a part 17 which is fixedly secured to the base 2 so as to rotate therewith and is therefore mounted so as to be jointly rotatable with the entire conveyor unit about the rotation axis U. Secured to the part 17 are two electric motors 6 extending downwards parallel with the rotation axis U. The motors 6 each drive a cooperating externally toothed cylindrical gear 8 with a reduction ratio of approximately 1:4000 via a cooperating multi-stage planetary gear 7. The two planetary gears 7 are flange-mounted on the housings of the motors 6. The shafts of the motors 6 and the rotation axes of the driving gears 8 and the output gear 9 are coaxial with the rotation axis U. The driving gears 8 respectively mesh with the common output gear 9.

Reference 18 denotes a slip ring body by means of which the motors 6 rotating about the rotation axis U when driven in rotation are supplied with electrical energy. The electric motors 6 could be replaced by hydraulic motors.

The roof 4 is mounted so as to be rotatable about the rotation axis U relative to the base 2 and the jacket 3, although it is not freely rotatable, but is joined via a kinematic coupling to the jacket 3, which is in turn fixedly joined to the base so as to rotate with it. Unlike the gears 8, 9 with external axes, the kinematic coupling is provided in the form of a gear mechanism with an internal axis, comprising at least one externally toothed driving gear similar to the driving gears 8 and an internally toothed output gear, i.e. an output ring. Apart from this pair of gears, the rotary drive for the roof 4 has at least one motor which, if the motors 6 are provided as electric motors, is preferably likewise an electric motor and, if the motors 6 are hydraulic motors, is preferably likewise a hydraulic motor, and a reduction gear of the same design as the reduction gear 7. The motor for the roof is preferably supported on the base 2, for example by means of the jacket 3. Alternatively, it could be supported on the roof 4, although this would require a power supply via an additional slip ring. The output gear of the roof drive is appropriately joined to the other tower components so as to be fixed thereto in rotation. Equipped with a drive of this type, the roof 4 can be driven in rotation relative to the jacket 3 and ultimately to the base about the rotation axis U. The base 2 absorbs the reaction torque exerted by the roof 4 when driven in rotation, namely via the kinematic coupling, and is therefore driven by the roof drive in the opposite direction of rotation from the roof 4 as a column of bulk material bears down on the roof 4 and the roof 4 therefore establishes a friction contact with the bulk material as it rotates. In principle, the roof drive would be enough to drive the base 2 and the jacket 3 in rotation and hence in particular cause the rotating motion of the conveyor screw 5. In practical terms, however, the supporting effect of the roof 4 caused by the friction contact is not enough to drive the conveyor screw 5 in rotation in most applications. The rotating motion of the conveyor screw 5 is primarily induced by the drive 6-9, which is set up with respect to the drive on the roof 4 so that the reaction torque exerted by the roof drive and the driving torque of the drive 6-9 point in the same direction, namely opposite the rotating motion of the roof 4.

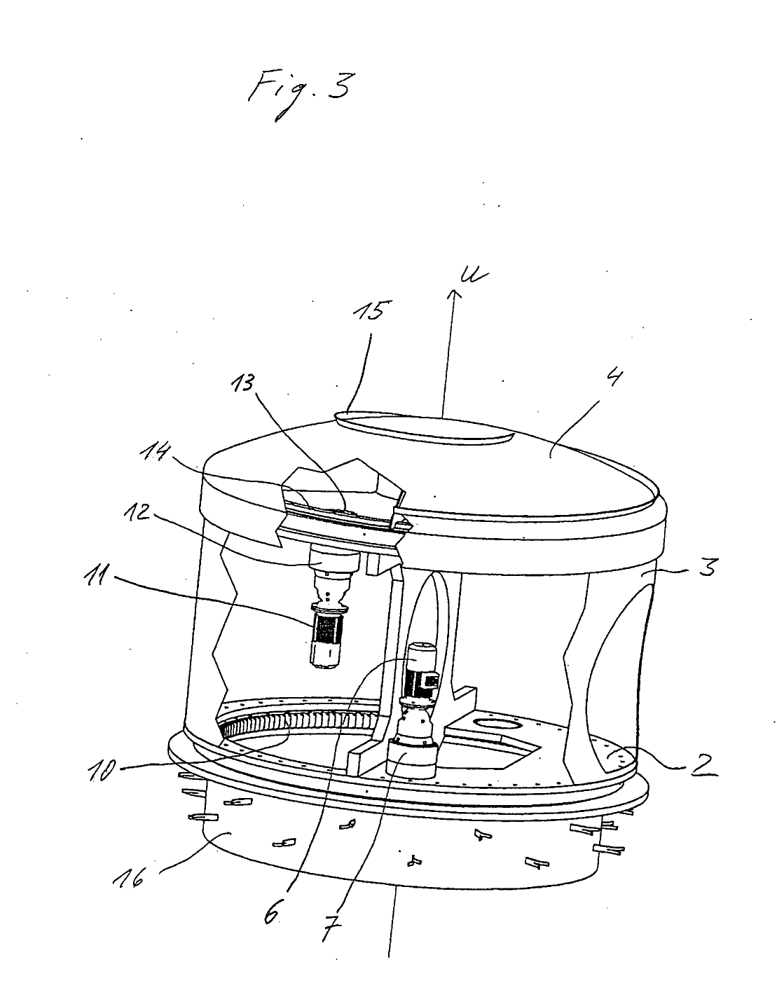

FIG. 3 illustrates the tower of a conveyor unit of a second variant with no conveyor screw 5, i.e. before it is fitted. The jacket 3 is only partially illustrated, so as to afford a view into the interior of the tower and onto its base 2. The conveyor unit of the second variant differs from the first variant as regards the two rotary drives, namely the drive for the roof 4 and the other drive for the base 2. The roof 4 has also been improved so that it can act as a bridge breaker by means of an effector device 15 secured to the roof 4, which tears apart bridge bases formed by the bulk material in the region of the roof 4 as the roof 4 rotates, so that they are destroyed or are even unable to start forming. The effector device 15 is provided in the form of a single web 15 extending in a closed arrangement, i.e. uninterrupted, around the rotation axis U in the form of a spiral. The roof 4 has a surface which cambers outwards away from the base 2. In the example illustrated, the roof 4 is a domed roof. Instead of a roundly cambered roof 4, the tower 2-4 could also be fitted with a conically shaped roof. The web 15 constituting the effector device 15 projects vertically from the roof 4 and has a height of a few centimeters.

The drive for the roof 4 consists of an electric motor 11, a flange-mounted reduction gear 12, an externally toothed driving gear 13 seated in a fixed arrangement on the output shaft of the reduction gear 12 so as to rotate therewith and an output gear 14 which meshes with the driving gear 13. The motor shaft and the rotation axis of the gears 13 and 14 are coaxial with the rotation axis U. The output gear 14 is an internally toothed ring and is fixedly secured to the roof 4 so as to rotate therewith. The roof 4 is supported by means of the output gear 14 and also by means of the jacket 3 and intermediate walls of the tower 2-4 on the base 2. The output gear 14 forms an inner bearing ring with a roller track for rolling elements of the rotary connection between the base 2 and the roof 4. The rotary connection is preferably a ball rotary connection designed to form a thrust-radial bearing in the form of a single ball bearing. The motor 11 is rigidly joined to the base 2 by means of the jacket 3 or an intermediate wall.

The other drive by means of which the base 2 is additionally driven in rotation has a single motor 6, a reduction gear 7, the output gear of which constitutes a driving gear, and also an internally toothed output gear 10 which replaces the externally toothed output gear 9 of the first variant. The motor 6, the reduction gear 7 and the output gear may be the same as those in the first variant. The output gear is fixedly joined to a frame 16, above which the tower 2-4 is secured in a stationary arrangement in the bulk material. The frame 16 is preferably embedded in a storage container by means of concrete. The motor 6 is rigidly connected to the base 2 and therefore supported so that it can drive the base 2 in rotation. The output gear 10 forms an inner bearing ring with a roller track for rolling elements of the rotary connection between the base 2 and the frame 16. The rotary connection is preferably an integrated ball rotary connection in order to form a thrust-radial bearing in the form of a single ball bearing.

The output gear 10 supports the entire tower 2-4 on the frame 16. The two rotary connections between the roof 4 and the base 2 and between the base 2 and the frame 16 may be identical in the sense of a modular system. In this sense, the integrated geared motor units 6, 7 and 11, 12 are also preferably identical.

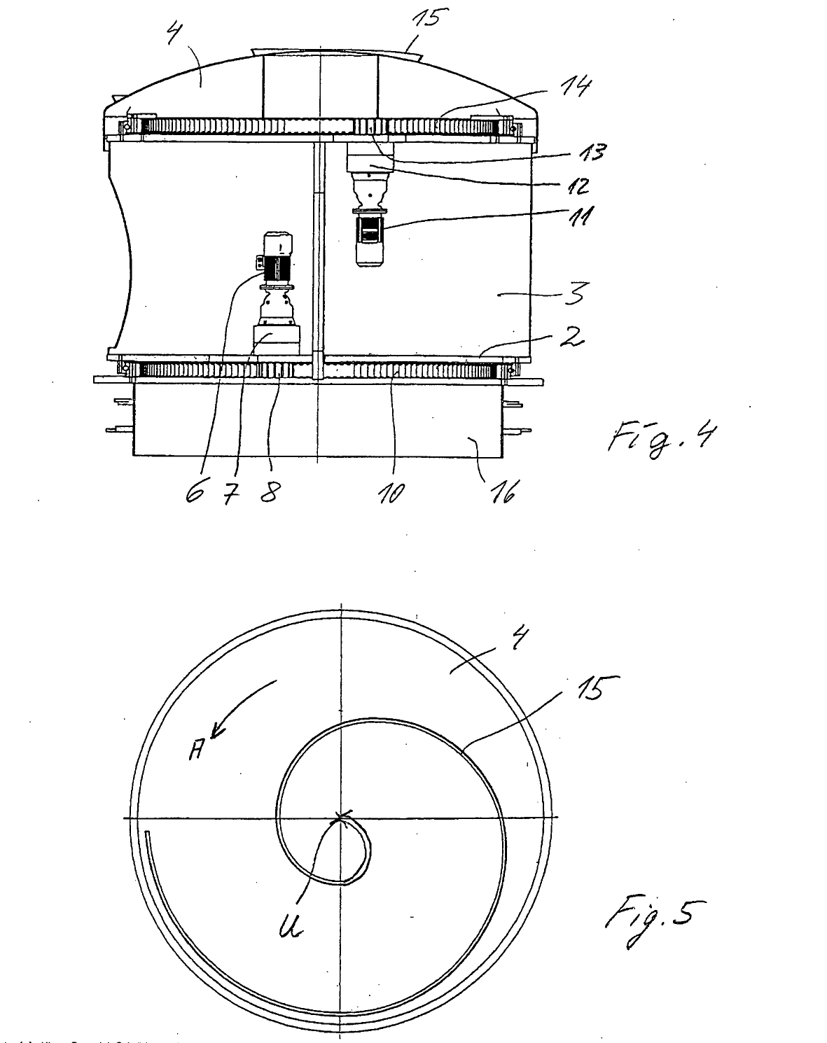

FIG. 4 illustrates the conveyor unit of the second variant in the form of a longitudinal section, the section plane of which contains the rotation axis U. Inside the tower 2-4, the motor 11 is suspended from a top platform rigidly joined to and rotating with the casing 3 and/or intermediate walls extending down towards the base 2 and the motor 6 projects up from the base 2 serving as a bottom platform towards the roof 4. The driving gears fixedly seated on the output shafts of the geared motor units 6, 7 and 11, 12 are denoted by references 8 and 13. The two pairs of gears 8, 10 and 13, 14 are advantageously identical, i.e. in the sense of a modular system, the driving gears 8 and 13 on the one hand and the output gears 10 and 14 on the other hand are identical. The motor 11 and also the gear mechanism 13, 14 disposed downstream are designed to be strong enough to overcome the adhesive friction and, during operation, sliding friction between the bulk material and the roof 4 on start-up when the bulk material is at its maximum height. The other drive 6-10 is designed so that it can apply the additional torque needed to drive the base 2 in rotation and in conjunction rotate the conveyer screw 5. Since the drive 11-14 for the roof 4 supplies some of the torque for the rotating motion, the other drive 6-10 may have a lower power rating than the drives of conventional devices. If particularly high torques are necessary, yet another or if necessary several other motors 6 may be used to drive the driving gear 14 in addition to the motor 6. Likewise, the gear 11-14 may be equipped with another and in principle even with several other motors 11, in order to drive the roof 4.

Driving motion for the roof 4 is also superimposed. The superimposed drive need only be such that the roof 4 effects a rotating motion relative to the bulk material, i.e. relative to the frame of the device. This rotating motion may be a rotating motion in the direction of the rotating motion of the base 2, albeit a delayed rotating motion compared with the rotation speed of the base 2. However, it is preferable if the roof 4 is driven so that it rotates in the direction of rotation of the base 2 relative to the frame 16 and in the opposite direction of rotation from the conveyor screw 5.

The motors 6 and 11 are controlled by a common or each by an individual motor control or automatic control system during operation in order to conform to a desired value for the motor torque. The pre-set desired values may be the same or different. In a preferred simple embodiment of the motor control or automatic control system, the desired values are not changed during operation.

The web 15 constituting the effector device 15 can best be seen from FIG. 5, which illustrates a plan view of the roof 4. The web 15 extends out from the rotation axis U in a spiral shape as far as an outer end close to the outer peripheral edge of the roof 4. The spiral formed by the web 15 extends around the rotation axis U across an angle of 540°. It is curved overall. Its radius of curvature, measured to the rotation axis U, increases constantly from the inner end of the web 15 lying on the rotation axis U to the outer end. At the outer end, the spiral web 15 runs at a tangent to an imaginary circle around the axis of rotation U. Arrow A indicates the direction of rotation of the roof 4 relative to the frame 16 during operation.

In the foregoing description, preferred embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A device for conveying bulk material, comprising:
a) a base with a bearing device for a rotary bearing about a rotation axis;
b) a conveyor unit extending out from the base, forming at least one transverse conveyor for conveying the bulk material transversely to the rotation axis or at least one feeding conveyor for feeding the bulk material to a transverse conveyor;
c) a roof for the base and the conveyor unit which is joined to the base so as to be rotatable about the rotation axis or about an axis extending at least substantially parallel with the rotation axis;
d) and a drive by means of which the roof can be driven in rotation relative to the base.

2. The device according to claim 1, wherein the drive kinematically couples the base and roof with one another and transmits a reaction torque to the base when the roof is driven in rotation.

3. The device according to claim 1, wherein the drive for the roof comprises a motor and a gear mechanism with a driving gear driven by the motor and an output gear driven by the driving gear, and the motor is supported by one of the base and the roof and the output gear is supported by the other.

4. The device according to claim 3, wherein the driving gear and the output gear are in rolling contact with one another, in which case the driving gear rolls on the output gear.

5. The device according to claim 3, wherein the motor drives the driving gear by means of a reduction gear which incorporates at least one rotating gear stage.

6. The device according to claim 3, wherein the output gear is rigidly joined to one of either the base or the roof.

7. The device according to claim 6, wherein the motor is rigidly joined to the other one of the base or roof.

8. The device according to claim 3, wherein the roof is supported on the base via the output gear and the output gear is part of a rotary bearing for the roof.

9. The device according to claim 8, wherein the output gear is part of a bearing ring of the rotary bearing.

10. The device according to claim 1, wherein, in order to drive the base in rotation about the rotation axis, another drive is provided and the base is kinematically or can be kinematically coupled with a frame by means of the other drive.

11. The device according to claim 10, wherein the other drive comprises another motor and another gear mechanism with another driving gear driven by the other motor and another output gear driven by the other driving gear, and the other motor is supported on one of either the base or frame and the other output gear is supported on the other.

12. The device according to claim 11, wherein the base is supported on the frame by means of the other output gear and the other output gear is part of a rotary bearing for the base.

13. The device according to claim 12, wherein the other output gear is part of a bearing ring of the rotary bearing.

14. The device according to claim 11, wherein the other motor is rigidly joined to one of either the base or frame.

15. The device according to claim 1, wherein an effector device is disposed on the roof, which destroys any bridges of bulk material which have formed.

16. The device according to claim 1, wherein the effector device has at least a passive effector element secured to the roof which is not driven relative to the roof.

17. The device according to claim 15, wherein the effector device or a part of the effector device is disposed on the roof in a spiral-shaped arrangement around the rotation axis.

18. The device according to claim 15, wherein tearing teeth standing proud of the roof constitute the effector device or part of the effector device.

19. The device according to claim 15, wherein the effector device has at least one active effector element which is driven relative to the roof.

20. The device according to claim 19, wherein the at least one active effector element is at least one of a rotary-driven screw, a rotary-driven sickle, a scarifier driven in translation or a blade driven in translation.

21. A store for bulk material comprising:
a) a storage container for bulk material;
b) a device according to claim 1, disposed in the storage container so as to be rotated with the base about the rotation axis for discharging the bulk material from the bottom.

22. A method of conveying bulk material stored in a storage container, in which a device according to claim 1 is disposed so that it can be rotated with the base about the rotation axis and a column of bulk material bears down on the device, whereby the conveyor unit conveys the bulk material in a direction extending transversely to the rotation axis or to a transverse conveyor conveying the bulk material transversely to the rotation axis and rotates about the rotation axis whilst conveying, and the roof is driven in rotation relative to the base and the bulk material.

23. The method according to claim 22, wherein a motor drives the roof in rotation relative to the base and another motor drives the base relative to the storage container and the motors are each torque-controlled.

24. The method according to claim 23, wherein the motors are torque-controlled each to conform to an unchanging torque when a column of bulk material is being discharged.

25. The method according to claim 22, wherein a motor drives the roof relative to the base in one direction of rotation and another motor drives the base relative to the storage container in the opposite direction.
